(19) United States
(12) Patent Application Publication
(10) Pub. No.: US 2017/0318800 A1
(43) Pub. Date: Nov. 9, 2017

(54) FREEZE-DRIED BIG GAME LURE

(71) Applicants: Nik Krohn, Saratoga Springs, UT (US); Charles E. Johnson, Saratoga Springs, UT (US); Richard Franklin LaRocco, Saratoga Springs, UT (US)

(72) Inventors: Nik Krohn, Saratoga Springs, UT (US); Charles E. Johnson, Saratoga Springs, UT (US); Richard Franklin LaRocco, Saratoga Springs, UT (US)

(21) Appl. No.: 15/146,267

(22) Filed: May 4, 2016

(51) Int. Cl. A01M 31/00; A01M 31/06

(52) U.S. Cl. CPC A01M 31/008; A01M 31/06; A01M 2200/00

(57) ABSTRACT

The present disclosure relates to a buck lure comprising an absorbable pad infused with deer urine and freeze-dried rendering the urine inert. When the pad is hydrated, the scent of the pad emits a scent which lures deer to the site from which the scent is emanating.

### FIELD OF THE INVENTION

This invention relates to hunting implements and more particularly relates to lures using urine to attract big game to a particular location.

### BACKGROUND

### Description of the Related Art

Big game lures of various species are known in the art, and big game lures which makes use of deer urine to attract deer to a hunter are also known. One method of hunting deer involves manipulation of the deer's developed sense of smell using deer urine to attract the animal to the hunter's vicinity.

Deer urine may be often used to tempt the buck into approaching a hunter, which, during the time that does are in heat or estrus and are sexually receptive, is effective in luring bucks. During rut season, a buck will mark off his territory. The buck will then attempt to prevent other bucks from entering his breeding territory, and it attuned to the scent of foreign deer urine.

The predominant type of deer lure used today is in the form of a liquid which comprises deer urine. The urine may be a combination of buck, doe and fawn urine, or simply a buck or doe. A preservative or diluting agent is usually also added. The fluid scent may simply be applied to a tree or the scent may be dispelled by placing the fluid in specially formed containers for dispensing the aromatic scent.

The problem with the lures of the prior art are plentiful. They emit an odor common to a deer, but more problematic is the inefficiencies imposed on the hunter by attempting to store and use liquid deer urine. Often the urine evaporates in storage on retail shelves, and even when opened, quickly disperses and becomes ineffective. The deer urine can be spilled, inadvertently mixed with human scent, is not easily transported, and infects a hunter's cloth with the urine scent. There exist no effective means in the art of storing, containing, transporting and making use of deer urine lures without these problems inherent to other lures in the art. A lure which overcomes these inefficiencies is desirable, and it is the object of the present invention to provide one.

### SUMMARY

From the foregoing discussion, it should be apparent that a need exists for an improved freeze-dried big game lure. Beneficially, such a device would overcome inefficiencies with the prior art. The present invention has been developed in response to the present state of the art, and in particular, in response to the problems and needs in the art that have not yet been fully solved by currently available air filter cleaners. Accordingly, the present invention has been developed to provide a freeze-dried big game lure, the lure comprising: an arrowhead-shaped flexible absorbable pad infused with urine of big game animal; the lure having two flanks, the flanks defining a separation recess between them; wherein, the urine infused into the lure is freeze-dried after infusion.

The flank may further define a branch recess. The lure may further comprise a notched end. The urine may comprise urine of a doe deer.

A method of luring a big game animal to a hunter is also provided, the steps of the method comprising: stamping an absorbable pad in the shape of a heart, a deer track, an arrowhead, or other shape, the pad having two flanks; defining a separation recess between the two flanks; spraying or dipping the absorbable pad in deer urine and infusing the deer urine into the absorbable pad; freeze-drying the absorbable pad after infusion of the deer urine; hydrating the absorbable pad with water in the wild; and using the hydrated pad to attract a buck deer.

For the purposes of this disclosure, the term “infusing” denotes causes an absorbable material to soak, or absorb, a liquid.

The method may further comprise vacuum packaging the absorbable pad in a polymeric bag, or a packaging or boxing the absorbable pad in packaging known to those of skill in the art.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a top perspective view of a freeze-dried big game lure in accordance with the prior art;

FIG. 2 is an entity-relationship diagram showing a freeze-dried big game lure in use accordance with the prior art;

FIG. 3 is a method of luring big game with a freeze-dried lure in accordance with the present invention;

FIG. 4 is an elevated-side perspective view of a freeze-dried big game lure in accordance with the prior art; and

FIG. 5 is a side perspective view of a freeze-dried big game lure in accordance with the prior art.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. The order in which a particular method occurs may or may not strictly adhere to the order of the corresponding steps shown.

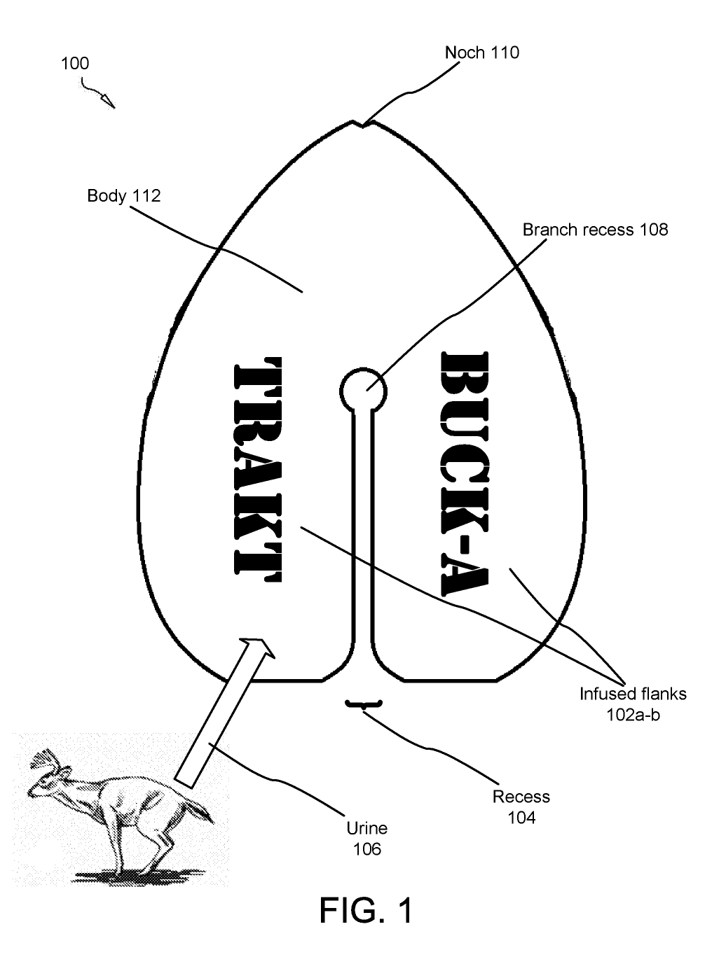

FIG. 1 is a top perspective view of a freeze-dried big game lure 100 in accordance with the prior art. The lure 100 comprises an arrowhead-shaped absorbable implement infused with deer urine 106.

The body 112 of the lure 100 is shaped as an inverted heart, deer track or arrowhead, but may be shaped as a triangle, circle, polygon, or irregularly-shaped. In the shown embodiment, the arrowhead shape serves to position the lure 100 on a tree branch, fence, power line, or any other thin protrusion. When disposed upon a tree branch through the branch recess 108, the lure 100 hangs with its infused flanks hanging downward as the center of gravity of the lure 100 is below the branch recess 108. The center of gravity of a circular or symmetrical lure 100 could be disposed below the branch 108 by raising the branch recess 108.

The infused flanks 102a-b are separated, as shown, by a separation recess 104, which may be cut, stamped, or otherwise created. The flanks 102a-b define the separation recess 104.

The flanks 102a-b are infused with deer urine 106, which is freeze-dried after infusion using means known to those of skill in the art. By freeze-drying the urine 106 after infusion, the scent of the lure 100 is all but eliminated until the lure 100 is hydrated by a hunter with water for use in the wild.

The lure 100 is rendered inert until hydrating, neither stinking nor evaporating and becoming useless. By freeze-drying the urine 106 after infusion into the absorbable lure 100, the lure cures defects in the prior art.

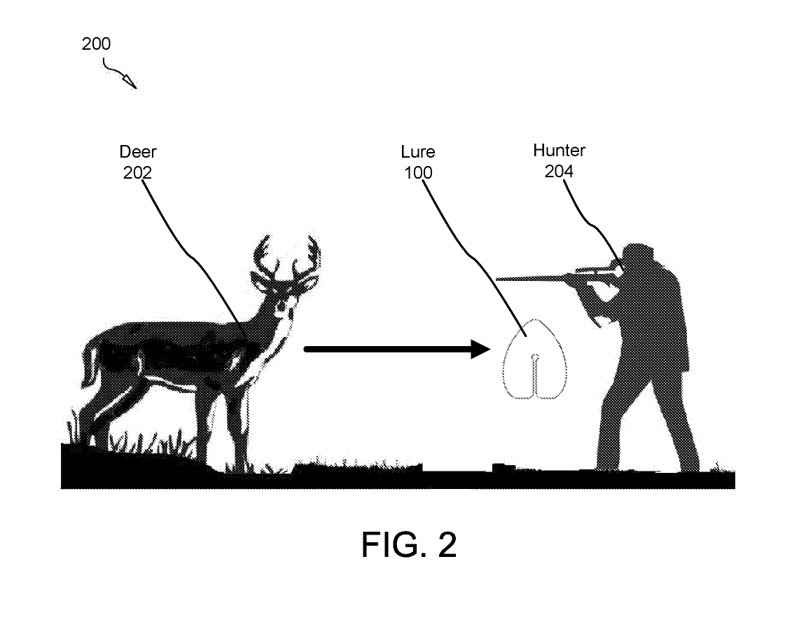

FIG. 2 is an entity-relationship diagram illustrating a relationship 200 between a freeze-dried big game lure in use in the wild with a deer in accordance with the prior art.

As shown, the deer 202 is attracted to a hunter 204 in possession of the lure 100. Because the lure is hydrated on site in the wild, using water either in the hunter's possession in the wild, the hunter can more easily ensure human scent is not mixed with the scent of the lure 100.

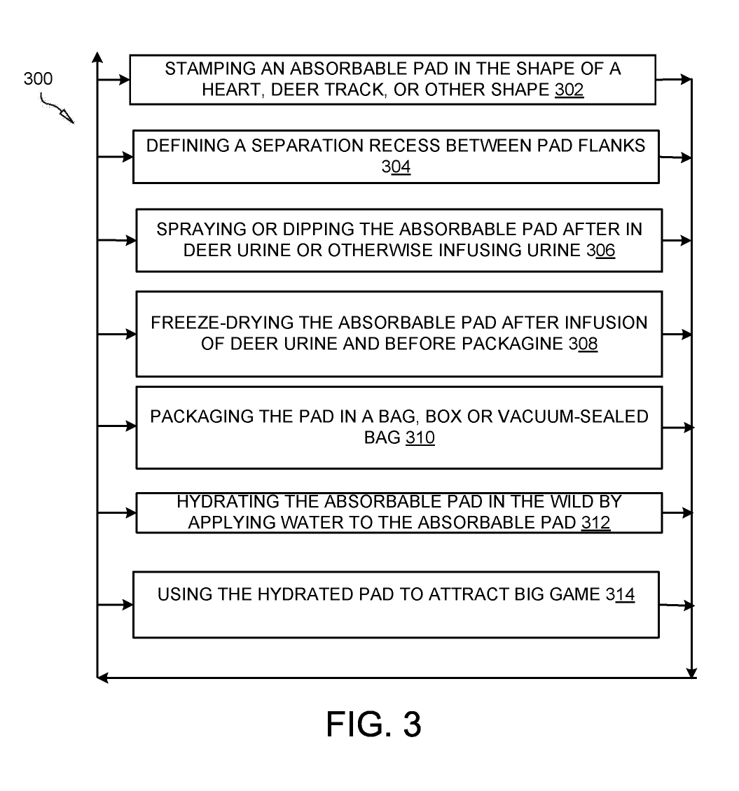

FIG. 3 is a method of luring big game with a freeze-dried lure in accordance with the present invention. The steps of the method may comprise stamping 302 or cutting an absorbable pad in the shape of a heart, deer track, arrowhead or other shape, the pad having two flanks, and defining 304 a separation recess between the two flanks.

A subsequent step may involve dipping 306 the absorbable pad in deer urine or otherwise infusing the deer urine into the absorbable pad (via spraying, pressure spraying, or other application), and freeze-drying 308 the absorbable pad after infusion of the deer urine.

The step of hydrating 310 the absorbable pad with water in the wild may follow, thereafter by using the hydrated pad to attract a buck deer.

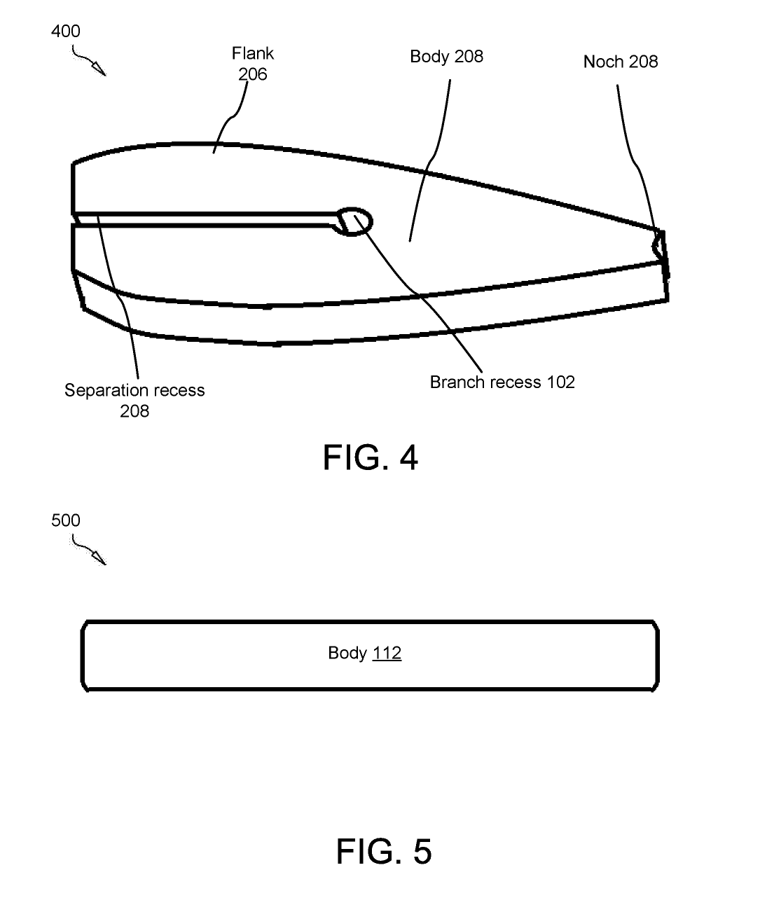

FIG. 4 is an elevated-side perspective view of a freeze-dried big game lure 400 in accordance with the prior art.

The big game lure 400 may be anywhere from 1 millimeter thick to six inches thick.

FIG. 5 is a side perspective view of a freeze-dried big game lure in accordance with the prior art.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A freeze-dried big game lure, the lure comprising:
a flexible absorbable pad infused with urine of big game animal, the flexible absorbable pad shaped as one of a deer track, heart and arrowhead;
the lure having two flanks, the flanks defining a separation recess between them;
wherein, the urine infused into the lure is freeze-dried after infusion.

2. The lure of claim 1, wherein the flanks further define a branch recess.

3. The lure of claim 1, further comprising a notched end.

4. The lure of claim 1, wherein the urine comprises urine a doe deer.

5. A method of luring a big game animal to a hunter, the steps of the method comprising:
stamping an absorbable pad in the shape of a deer track, the pad having two flanks;
defining a separation recess between the two flanks;
infusing the absorbable pad with deer urine;
freeze-drying the absorbable pad after infusion of the deer urine;
hydrating the absorbable pad with water in the wild; and
using the hydrated pad to attract a buck deer.

6. The method of claim 5, further comprising packaging the absorbable pad in a polymeric bag.
